(19) United States
(12) Patent Application Publication
(10) Pub. No.: US 2026/0077379 A1
(43) Pub. Date: Mar. 19, 2026

(54) APPARATUS FOR MANUFACTURING A SECONDARY BATTERY AND METHOD OF MANUFACTURING THE SECONDARY BATTERY

(71) Applicant: SAMSUNG SDI CO., LTD., Yongin-si (KR)

(72) Inventor: Taeyoung KWON, Yongin-si (KR)

(21) Appl. No.: 19/093,466

(22) Filed: Mar. 28, 2025

(30) Foreign Application Priority Data
Sep. 13, 2024 (KR) 10-2024-0126018

(51) Int. Cl. B05C 9/14; B05C 5/02; F26B 3/04; F26B 21/00; H01M 4/04

(52) U.S. Cl. CPC B05C 9/14; B05C 5/0254; H01M 4/0402; F26B 3/04; F26B 21/50

(57) ABSTRACT

An apparatus for manufacturing a secondary battery. The apparatus includes a coating device configured to form a coating layer by applying a slurry to a substrate being transported in a transport direction, an air blower configured to blow air toward the coating layer, and a controller configured to control the coating device and the air blower. The air blower includes a first air blower disposed above the coating layer and configured to blow air toward a top surface of the coating layer and a second air blower disposed adjacent to opposite sides of the coating layer and configured to blow air toward opposite side surfaces of the coating layer. The controller is configured to adjust a temperature of the blown air based on at least one of a width of the coating layer or a thickness of the coating layer.

### CROSS REFERENCE TO RELATED APPLICATION

The present application claims priority to and the benefit of Korean Application No. 10-2024-0126018, filed on Sep. 13, 2024, in the Korean Intellectual Property Office, the entire disclosure of which is incorporated by reference herein.

### BACKGROUND

### 1. Field

The present disclosure relates to a secondary battery manufacturing apparatus and method of manufacturing a secondary battery. More particularly, the present disclosure relates to a secondary battery manufacturing apparatus and method using an air blower and a coating device for manufacturing electrode plates for a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries may be manufactured by inserting into a case an electrode assembly including a positive electrode plate, a negative electrode plate, and a separator and then sealing the resulting structure with a cap assembly. The positive electrode plate may be manufactured by coating an electrode collector (or electrode current collector), formed from aluminum, with a slurry (for a positive electrode active material) using a die coater and then drying the slurry-coated electrode collector. The negative electrode plate may be manufactured by coating an electrode collector, formed from copper, with a slurry (for a negative electrode active material) using a die coater and then drying the slurry-coated electrode collector. The dispersion of the mass per area (i.e., loading level) of the slurry may increase when a coating rate of the slurry increases, thereby decreasing the coating quality of the positive electrode plate or the negative electrode plate. That is, if the slurry is applied unevenly or is not applied at a predetermined coating thickness, the reliability of the secondary battery may decrease.

The above information disclosed in this Background section is for enhancement of understanding of the background of the present disclosure, and therefore, it may contain information that does not constitute related (or prior) art.

### SUMMARY

An objective of the present disclosure is to provide an apparatus for manufacturing a secondary battery and a method of making the secondary battery, the apparatus and the method intended to solve the problems described above.

These and other aspects and features of the present disclosure will be described in or will be apparent from the following description of embodiments of the present disclosure.

Some embodiments of the present disclosure include an apparatus for manufacturing a secondary battery. The apparatus includes a coating device configured to form a coating layer by applying a slurry to a substrate being transported in a transport direction, an air blower configured to blow air toward the coating layer, and a controller configured to control the coating device and the air blower. The air blower includes a first air blower disposed above the coating layer and configured to blow air toward a top surface of the coating layer and a second air blower disposed adjacent to opposite sides of the coating layer and configured to blow air toward opposite side surfaces of the coating layer. The controller is configured to adjust temperature of the air from the first air blower and a temperature of the air from the second air blower based on at least one of a width of the coating layer or a thickness of the coating layer.

According to some embodiments of the present disclosure, the temperature of the air from the first air blower or the temperature of the air from the second air blower ranges from 80° C. to 150° C.

According to some embodiments of the present disclosure, the controller is configured to adjust a blowing speed of the air from the first air blower and a blowing speed of the air from the second air blower, based on at least one of the width of the coating layer or the thickness of the coating layer.

According to some embodiments of the present disclosure, the controller is configured to adjust the temperature of the air from the first air blower and the temperature of the air from the second air blower, based on properties of the slurry.

According to some embodiments of the present disclosure, the controller is configured to adjust the blowing speed of the air from the first air blower and the blowing speed of the air from the second air blower based on properties of the slurry.

According to some embodiments of the present disclosure, the controller is configured to adjust the temperature of the air from the first air blower and the temperature of the air from the second air blower, based on a transport rate of the substrate.

According to some embodiments of the present disclosure, the controller is configured to adjust the blowing speed of the air from the first air blower and the blowing speed of the air from the second air blower based on a transport rate of the substrate.

According to some embodiments of the present disclosure, the first air blower includes nozzles in a Z pattern.

According to some embodiments of the present disclosure, the Z pattern includes a first straight line, a second straight line connected to the first straight line, and a third straight line connected to the second straight line, and the first straight line and the third straight line are parallel to each other.

According to some embodiments of the present disclosure, a start point of the Z pattern is on a first virtual line, an end point of the Z pattern is on the first virtual line, and the first virtual line extends in the transport direction and passes through a center of the coating layer.

According to some embodiments of the present disclosure, a first end of the first straight line is on the first virtual line, a second end of the first straight line is on a second virtual line, and the second virtual line extends in the transport direction along a first side surface of the coating layer.

According to some embodiments of the present disclosure, a point where the second straight line and the third straight line meet is on a third virtual line, and the third virtual line extends in the transport direction along a second side surface of the coating layer.

According to some embodiments of the present disclosure, a first end of the third straight line is on a third virtual line, a second end of the third straight line is on the first virtual line, and the third virtual line extends in the transport direction along a second side surface of the coating layer.

According to some embodiments of the present disclosure, the first air blower includes a rotating member configured to rotate the nozzles in the Z pattern in a clockwise direction or in a counterclockwise direction.

According to some embodiments of the present disclosure, the first air blower and the second air blower are spaced apart from each other in the transport direction.

Some embodiments of the present disclosure include a method of manufacturing a secondary battery including forming, using a coating device, a coating layer by applying slurry to a substrate transported in a transport direction, blowing, using a first air blower disposed above the coating layer, air from the first air blower toward a top surface of the coating layer, blowing, using a second air blower disposed adjacent to opposite sides of the coating layer, air from the second air blower toward opposite side surfaces of the coating layer, and adjusting, via a controller, at least one of (i) a temperature of the air from the first air blower and a blowing temperature of the air from the second air blower or (ii) a blowing speed of the air from the first air blower and a blowing speed of the air from the second air blower based on at least one of a width of the coating layer or a thickness of the coating layer.

According to some embodiments of the present disclosure, the controller adjusts the temperature of the air from the first air blower or the temperature of the air from the second air blower to be in a range from 80° C. to 150° C.

According to some embodiments of the present disclosure, the method further includes adjusting, by the controller, at least one of (i) the temperature of the air from the first air blower and the temperature of the air from the second air blower or (ii) the blowing speed of the air from the first air blower and the blowing speed of the air from the second air blower, based on properties of the slurry.

According to some embodiments of the present disclosure, the method further includes controlling, using the controller, at least one of (i) the temperature of the air from the first air blower and the temperature of the air from the second air blower or (ii) the blowing speed of the air from the first air blower and the blowing speed of the air from the second air blower based on a transport rate of the substrate.

According to some embodiments of the present disclosure, blowing the air toward the top surface of the coating layer includes blowing the air in a first straight line, blowing the air in a second straight line from an end of the first straight line, and blowing the air in a third straight line from an end of the second straight line. The first straight line and the third straight line are parallel to each other.

The air blower according to some embodiments of the present disclosure may include a first air blower configured to blow air to a top surface of the coating layer and a second air blower configured to blow air to opposite side surfaces of the coating layer. Accordingly, as a coating rate and/or a dispensing amount of the slurry increases, edge portions of the coating layer that are not coated uniformly may be corrected. As a result, a thickness of a central portion of the coating layer and a thickness of the edge portion of the coating layer may be substantially the same, thereby improving the uniformity of the coating.

In addition, the controller may control the first air blower and the second air blower to adjust a temperature of air from the first air blower and/or a temperature of air from the second air blower and/or a blowing speed of the air from the first air blower and/or a blowing speed of the air from the second air blower, based on at least one of width of the coating layer, thickness of the coating layer, properties of the slurry, or a transport rate of the substrate. With such a configuration, uniformity of the coating layer may be maintained in response to the coating conditions of the slurry, despite changes of the coating layer due to process reasons. As a result, the energy density of the secondary battery may be improved, and the reliability of the secondary battery may be improved.

In addition, the first air blower may include nozzles in a Z pattern. In a case where an air blower such as an air knife is used, defects such as streaks may occur on the coating surface. However, the Z pattern of the nozzles of the first air blower is configured such that a start point and an end point thereof are on a virtual line passing through the center of the coating layer. That is, the top surface of the coating layer may be formed flat in a case where the Z pattern is used, and uniformity of the thickness of the coating layer may be improved.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a schematic view of a secondary battery manufacturing apparatus according to the present disclosure.

FIG. 2 is a perspective view of the secondary battery manufacturing apparatus according to the present disclosure.

FIG. 3 is a cross-sectional view taken along line A-A of FIG. 2 according to the present disclosure.

FIG. 4 is a plan view of the first air blower according to the present disclosure.

FIG. 5 is a cross-sectional view taken along line B-B of FIG.

FIG. 6 is a cross-sectional view taken along line C-C of FIG.

FIG. 7 is a cross-sectional view of the secondary battery manufacturing apparatus according to the present disclosure.

FIG. 8 is a plan view of the first air blower according to the present disclosure.

FIG. 9 is a perspective view of the secondary battery manufacturing apparatus according to the present disclosure.

FIG. 10 is also a perspective view of the secondary battery manufacturing apparatus according to the present disclosure.

FIG. 11 shows a method of manufacturing a secondary battery according to the present disclosure.

### DETAILED DESCRIPTION OF THE EMBODIMENTS

Hereinafter, embodiments of the present disclosure will be described, in detail, with reference to the accompanying drawings. The terms or words used in this specification and claims should not be construed as being limited to the usual or dictionary meaning and should be interpreted as meanings and concepts that are consistent with the technical idea of the present disclosure based on the principle that the inventor can be his/her own lexicographer to appropriately define the concept of a term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Herein, singular forms are intended to include plural forms, unless the context clearly indicates otherwise. Plural forms are also intended to include singular forms, unless the context clearly indicates otherwise. In addition, it will be understood throughout the specification that terms “comprise”, “include”, “have”, and any variations thereof are intended to cover non-exclusive elements unless explicitly described to the contrary.

In the present disclosure, the sizes and relative sizes of layers and regions shown in the drawings may be exaggerated to present a clearer description of sizing of an element. That is, the sizes shown in the drawings are for ease of understanding and are not intended to be limiting. In addition, throughout the specification, similarly ordered reference numerals refer to similar components.

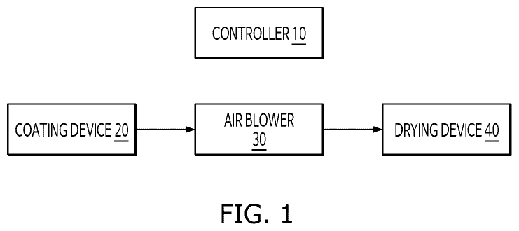

FIG. 1 is a schematic view of a secondary battery manufacturing apparatus according to the present disclosure. The secondary battery manufacturing apparatus may include a controller 10, a coating device 20, an air blower 30, and a drying unit 40.

The coating device 20 may include a tank configured to store slurry, a control valve configured to control a supply of the slurry, a die coater configured to dispense the slurry to a substrate, and/or the like. The control valve may control the amount of slurry supplied to the die coater from the tank. The die coater may form a coating layer when applying the slurry to the substrate, as the substrate is transported in the transport direction. The controller 10 may control the coating device 20 to adjust the amount of the slurry dispensed. The width and/or thickness of the coating layer formed on the substrate is based on the amount of the slurry dispensed by the coating device 20.

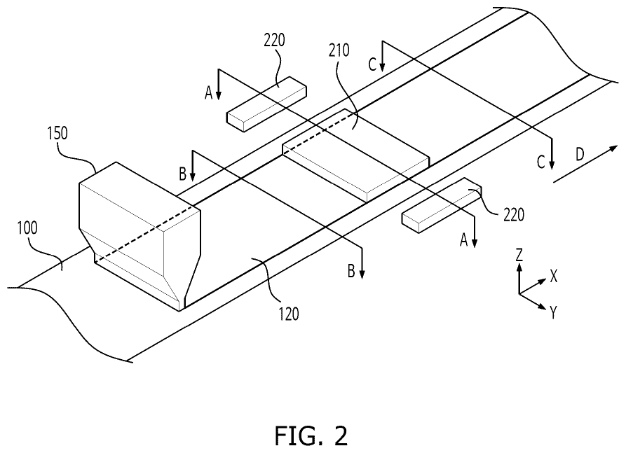

The air blower 30 may blow air onto the coating layer formed by the coating device 20. The air blower 30 may blow air onto an upper surface and/or side surfaces of the coating layer, thereby uniformly shaping surfaces of the coating layer. The air blower 30 may include, for example, a first air blower 210 (FIG. 2) and a second air blower 220 (FIG. 2). The gas blown by the air blower 30 may be air, but the present disclosure is not limited thereto. The gas may be any gas as long as the gas does not cause a chemical reaction in the coating layer. The air blower 30 may adjust a temperature and/or a blowing speed of the blown air under the control of the controller 10. By adjusting the temperature and/or the blowing speed of the air blown by the air blower 30, the surface of the coating layer may be effectively and uniformly formed.

The drying device 40 may dry the coating layer after the coating layer has passed through the air blower 30. The drying device 40 may include a chamber, a steam supply configured to supply superheated steam into the chamber, a heater configured to heat the superheated steam, and/or the like. Accordingly, the drying device 40 may evaporate a solvent present in the coating layer. In FIG. 1, the drying device 40 is shown as a separate configuration from the air blower 30, but the present disclosure is not limited thereto. For example, the air blower 30 may be included within the drying device 40 or may be a part of the drying device 40. In another example, the air blower 30 may replace a role of the drying device 40, and the drying device 40 may be omitted.

The controller 10 may control the coating device 20. For example, the controller 10 may control the amount of slurry dispensed by the coating device 20. The controller 10 may also control a coating width and/or a speed of which the coating device 20 dispenses slurry. The controller 10 may control the air blower 30. For example, the controller 10 may control the first air blower 210 (FIG. 2) and the second air blower 220 (FIG. 2) of the air blower 30. Specifically, the controller 10 may control the first air blower and the second air blower of the air blower 30 to adjust (i) the temperature of the air blown by the first air blower and/or the temperature of the air blown by the second air blower the second air blower and/or (ii) the blowing speed of the air blown by the first air blower and/or the blowing speed of the air blown by the second air blower. The controller 10 may control the drying device 40. For example, the controller 10 may control the steam supply of the drying device 40 and/or the heater of the drying device 40.

In an embodiment, the controller 10 may control the first air blower and the second air blower of the air blower 30 to adjust the temperature of the air, based on at least one of a width or a thickness of the coating layer formed on the substrate. For example, the controller 10 may control the first air blower and the second air blower of the air blower 30 so that the temperature of the air of the first air blower and/or the temperature of the air of the second air blower increases as the width of the coating layer increases. In another example, the controller 10 may control the first air blower and the second air blower of the air blower 30 so that the temperature of the air from the first air blower and/or the temperature of the air of the second air blower increases as the thickness of the coating layer increases. The temperature of the air from the first air blower and/or the temperature from the air of the second air blower may be in a range from 80° C. to 150° C., but the present disclosure is not limited thereto. A temperature range of the air may be determined to be a range suitable for effective evaporation of the solvent in the slurry without affecting the properties of the slurry.

In an embodiment, the controller 10 may control the first air blower and/or the second air blower of the air blower 30 to adjust the blowing speed of the air of the first air blower and/or the blowing speed of the air of the second air blower, based on at least one of the width or the thickness of the coating layer formed on the substrate. For example, the controller 10 may control the first air blower and the second air blower of the air blower 30 so that the blowing speed of the air of the first air blower and/or the blowing speed of the air of the second air blower increases as the width of the coating layer increases. In another example, the controller 10 may control the first air blower and the second air blower of the air blower 30 so that the blowing speed of the air of the first air blower and/or the blowing speed of the air of the second air blower increases as the thickness of the coating layer increases.

In an embodiment, the controller 10 may control the first air blower and the second air blower of the air blower 30 to adjust the temperature of the air of the first air blower and/or the temperature of the air of the second air blower, based on the properties of the slurry dispensed by the coating device 20. For example, the controller 10 may control the first air blower and the second air blower of the air blower 30 so that the temperature of the air of the first air blower and/or the temperature of the air of the second air blower increases as the solute content of the slurry decreases. In another example, the controller 10 may control the first air blower and the second air blower of the air blower 30 so that the temperature of the air of the first air blower and/or the temperature of the air of the second air blower increases as volatility of the solvent in the slurry decreases. The temperature of the air of the first air blower and/or the temperature of the air of the second air blower may each range from 80° C. to 150° C., but the present disclosure is not limited thereto. The temperature range of the air may be a range suitable for effective evaporation of the solvent in the slurry without affecting properties of the slurry.

In an embodiment, the controller 10 may control the first air blower and the second air blower of the air blower 30 to adjust the blowing speed of the air of the first air blower and/or the blowing speed of the air of the second air blower, based on the properties of the slurry dispensed by the coating device 20. For example, the controller 10 may control the first air blower and the second air blower of the air blower 30 so that the blowing speed of the air of the first air blower and/or the blowing speed of the air of the second air blower increases as the solute content of the slurry decreases. In another example, the controller 10 may control the first air blower and the second air blower of the air blower 30 so that the blowing speed of the air of the first air blower and/or the blowing speed of the air of the second air blower increases as the volatility of the solvent in the slurry decreases.

In an embodiment, the controller 10 may control the first air blower and the second air blower of the air blower 30 to adjust the temperature of the air of the first air blower and/or the temperature of the air of the second air blower based on the transport rate of the substrate. For example, the controller 10 may control the first air blower and the second air blower of the air blower 30 so that the temperature of the air of the first air blower and/or the temperature of the air of the second air blower increases as a transport rate of a base material increases. The temperature of the air of the first air blower and/or the temperature of the air of the second air blower may each range from 80° C. to 150° C., but the present disclosure is not limited thereto. The temperature range of the air may be a range suitable for effective evaporation of the solvent in the slurry without affecting the properties of the slurry.

In an embodiment, the controller 10 may control the first air blower and the second air blower of the air blower 30 to adjust the blowing speed of the air of the first air blower and/or the blowing speed of the air of the second air blower based on a feed rate of the substrate. For example, the controller 10 may control the first air blower and the second air blower of the air blower 30 so that the blowing speed of the air of the first air blower and/or the blowing speed of the air of the second air blower increases as the transport rate of the substrate increases.

FIG. 2 is a perspective view of the secondary battery manufacturing apparatus according to embodiments of the present disclosure. The secondary battery manufacturing apparatus according to embodiments of the present disclosure may include a coating device 150, a first air blower 210, a second air blower 220, and a drying device (not shown).

The coating device 150 may apply a slurry to the substrate 100 being transported in a transport direction D to form a coating layer 120. The coating device 150 may correspond to the coating device 20 of FIG. 1. The coating device 150 may store a slurry therein. The slurry may be, for example, an active material slurry in which a binder solution is mixed with an active material and a conductive agent or an additive. The slurry may be an active material slurry used to manufacture positive electrode plates or negative electrode plates of secondary batteries. The coating device 150 may dispense a slurry stored in the coating device 150 to the surface of the substrate 100 to form the coating layer 120. The coating device 150 may adjust the width and/or the thickness of the coating layer 120 by adjusting a slot die from which the slurry is dispensed.

The substrate 100 may be wound on a roll. The substrate 100 may be transported in the transport direction D by transport rollers or the like. The transport direction D may be the same as a first direction X. The first direction X is a direction along the X-axis. The substrate 100 may be an electrode plate used to manufacture a positive electrode plate or a negative electrode plate of a secondary battery. The substrate 100 may be a thin sheet of conductive metal formed from copper, a copper alloy, nickel, or a nickel alloy.

The coating layer 120 may be provided on a surface of the substrate 100. The width of the coating layer 120 is shown as being less than the width of the substrate 100, but the width shown is not limiting as to the sizing of the width of the coating layer 120 compared to the width of the substrate 100. For example, the coating layer 120 is shown as exposing opposite ends of the substrate 100, but, in other embodiments, the coating layer 120 may cover only one end of the substrate 100 or may cover the opposite ends of the substrate 100. Herein, the width of each of the substrate 100 and the coating layer 120 refers to the width in a second direction Y. The second direction Y is a direction along the Y-axis and is perpendicular to the first direction X. A third direction Z is a direction along the Z-axis and is perpendicular to each of the first direction X and the second direction Y.

The first air blower 210 and the second air blower 220 may correspond to the air blower 30 of FIG. 1. The first air blower 210 may be disposed above the coating layer 120. The first air blower 210 may blow air toward a top surface of the coating layer 120. The second air blower 220 may be disposed adjacent to opposite sides of the coating layer 120. Thus, the second air blower 220 may blow air toward opposite side surfaces of the coating layer 120.

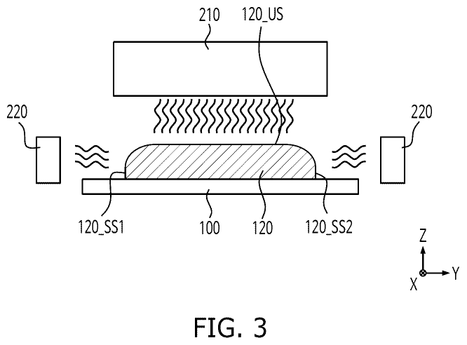

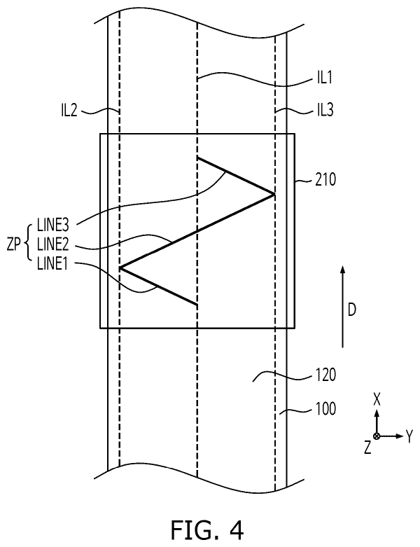

The first air blower 210 and the second air blower 220 will now be described in detail with reference to FIGS. 3 and 4.

FIG. 3 is a cross-sectional view taken along line A-A of FIG. 2 according to the present disclosure. The first air blower 210 may be spaced apart from the top surface 120_US of the coating layer 120 in the third direction Z. The first air blower 210 may blow air toward the top surface 120_US of the coating layer 120. The first air blower 210 may include a Z pattern ZP (FIG. 4) of nozzles to blow air.

The second air blower 220 may be spaced apart in the second direction Y from the opposite side surfaces 120_SS1 and 120_SS2 of the coating layer 120. The second air blower 220 may blow air toward the first side surface 120_SS1 and the second side surface 120_SS2 of the coating layer 120. While a direction of the air blown by the second air blower 220 is the second direction Y, the present disclosure is not limited thereto.

In an embodiment, the controller 10 (FIG. 1) may control the temperature of the air of the first air blower 210 and/or the temperature of the air of the second air blower 220. For example, the controller 10 may control the temperature of the air of the first air blower 210 and/or the temperature of the air of the second air blower 220, based on at least one of the width of the coating layer 120 or the thickness of the coating layer 120. In another example, the controller 10 may control the temperature of the air of the first air blower 210 and/or the temperature of the air of the second air blower 220, based on the properties of the slurry. In another example, the controller 10 may control the temperature of the air of the first air blower 210 and/or the temperature of the air of the second air blower 220, based on the transport rate of the substrate 100.

In an embodiment, the controller 10 may control the blowing speed of the first air blower 210 and/or the blowing speed of the air of the second air blower 220. For example, the controller 10 may control the speed of the air of the first air blower 210 and/or the speed of the air of the second air blower 220, based on at least one of the width of the coating layer 120 or the thickness of the coating layer 120. In another example, the controller 10 may control the blowing speed of the air of the first air blower 210 and/or the blowing speed of the air of the second air blower 220, based on the properties of the slurry. In another example, the controller 10 may control the blowing speed of the air of the first air blower 210 and/or the blowing speed of the air of the second air blower 220, based on the transport rate of the substrate 100.

Although not shown, the secondary battery manufacturing apparatus according to some embodiments of the present disclosure may further include a supply configured to supply air, a heater configured to adjust the temperature of the air of the first air blower 210 and/or the temperature of the air of the second air blower 220, and supply lines connecting the supply to each of the first air blower 210 and the second air blower 220. The controller 10 may control the supply to control the operation of the first air blower 210 and the second air blower 220. For example, the controller 10 may cause the first air blower 210 and the second air blower 220 to operate substantially at the same time. In another example, the controller 10 may cause the first air blower 210 and the second air blower 220 to operate at different times. The controller 10 may also control the heater to adjust the temperature of the air of the first air blower 210 and/or the temperature of the air of the second air blower 220. The temperature of the air of the first air blower 210 and/or the temperature of the air of the second air blower 220 may each be in a range from 80° C. to 150° C., but the present disclosure is not limited thereto.

FIG. 4 is a plan view of the first air blower according to the present disclosure. A Z pattern ZP is provided on the bottom surface of the first air blower 210. For simplification purposes, the coating layer 120 is not shown.

The first air blower 210 may include nozzles in a Z pattern ZP provided on the bottom surface of the first air blower 210. The first air blower 210 may blow air in the Z pattern ZP through the nozzles. The bottom surface of the first air blower 210 may face the top surface 120_US of the coating layer 120. The Z pattern ZP may refer to a pattern in the shape of the letter Z. A more specific shape of the Z pattern ZP is described below.

The Z pattern ZP may include a first straight line LINE1, a second straight line LINE2, and a third straight line LINE3. The first straight line LINE1 may be connected to the second straight line LINE2. The second straight line LINE2 may be connected to the third straight line LINE3. The first straight line LINE1 is not connected to the third straight line LINE3. That is, the first straight line LINE1, the second straight line LINE2, and the third straight line LINE3 may be connected sequentially to form a Z shape.

A thickness shown for each of the first straight line LINE1, the second straight line LINE2, and the third straight line LINE3 in FIG. 4 is exemplary and the present disclosure is not limited to the depicted thicknesses. For example, the thickness of each of the first straight line LINE1, the second straight line LINE2, and the third straight line LINE3 may be thicker or thinner than shown.

In some embodiments, a first end of the first straight line LINE1 may be disposed on a first virtual line IL1. The first end of the first straight line LINE1 disposed on the first virtual line IL1 may be a start point of the Z pattern ZP. The first virtual line IL1 may be a virtual straight line extending in the transport direction D and passing through the center of the coating layer 120. A second end of the first straight line LINE1 may be disposed on a second virtual line IL2. The second virtual line IL2 may be a virtual straight line extending in the transport direction D along the first side surface 120_SS1 of the coating layer 120. The second end of the first straight line LINE1 may be connected to a first end of the second straight line LINE2. That is, the first end of the second straight line LINE2 may be disposed on the second virtual line IL2.

The first end of the second straight line LINE2 may be connected to the first straight line LINE1 on the second virtual line IL2. A second end of the second straight line LINE2 may be disposed on the third virtual line IL3. The third virtual line IL3 may be a virtual straight line extending in the transport direction D along the second side surface 120_SS2 of the coating layer 120. The second end of the second straight line LINE2 may be connected to a first end of the third straight line LINE3. Thus, the first end of the third straight line LINE3 may be disposed on the third virtual line IL3.

The first end of the third straight line LINE3 may be connected to the second straight line LINE2 on the third virtual line IL3. The second end of the third straight line LINE3 may be disposed on the first virtual line IL1. The second end of the third straight line LINE3 disposed on the first virtual line IL1 may be an end point of the Z pattern ZP.

In some embodiments, the first straight line LINE1 and the third straight line LINE3 may be parallel to each other. However, the present disclosure is not limited thereto.

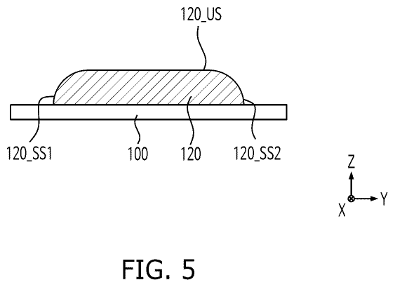

FIG. 5 is a cross-sectional view taken along line B-B of FIG. 2 according Each of the first side surface 120_SS1 and the second side surface 120_SS2 of the coating layer 120 may have a curved shape. The first side surface 120_SS1 and the second side surface 120_SS2 of the coating layer 120 may be surfaces facing the coating layer 120 in the second direction Y. The top surface 120_US of the coating layer 120 may be relatively flat compared to the opposite side surfaces 120_SS1 and 120_SS2 of the coating layer 120. The top surface 120_US of the coating layer 120 may be a highest surface portion of the coating layer 120 with respect to the third direction Z, the top surface 120_US set apart from the first side surface 120_SS1 and the second side surface 120_SS2.

As shown in FIG. 5, before the substrate 100 passes through the area where the air blower (210 and 220 of FIG. 2) is disposed, the thickness of the central portion of the coating layer 120 and the thickness of the edge portion of the coating layer 120 may be non-uniform. Particularly, the thickness of the edge portion of the coating layer 120 may be thinner than the thickness of the central portion of the coating layer 120. In such a case, the positive electrode plate and/or the negative electrode plate may not display desired electrical characteristics, and a reliability of the secondary battery may be reduced.

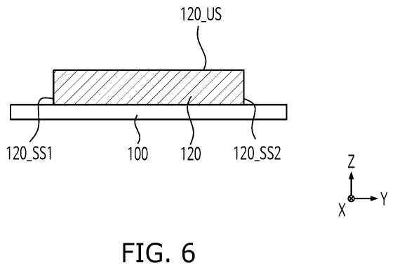

However, according to embodiments of the present disclosure, as the first air blower 210 and the second air blower 220 blow air onto the coating layer 120, the opposite side surfaces 120_SS1 and 120_SS2 of the coating layer 120 may be planarized (see e.g., FIG. 6).

FIG. 6 is a cross-sectional view taken along line C-C of FIG. 2. The opposite side surfaces 120_SS1 and 120_SS2 of the coating layer 120 may have a substantially planar shape. Although the opposite side surfaces 120_SS1 and 120_SS2 of coating layer 120 are shown to be completely planar in FIG. 6, such a completely planar configuration is exemplary and illustrative. In some embodiments, the opposite side surfaces 120_SS1 and 120_SS2 of coating layer 120 may not be completely planar but may be more planar than the opposite side surfaces 120_SS1 and 120_SS2 of coating layer 120 in FIG. 3 and FIG. 5.

As the substrate 100 passes through the section where the first air blower 210 and the second air blower 220 are disposed, the coating layer 120 may be shaped so that the thickness of the central portion thereof and the thickness of the edge portion thereof are uniform. In addition, the solvent in the coating layer 120 may be evaporated by air blown by the first air blower 210 and/or the second air blower 220 so that a shape of the coating layer 120 as shown in FIG. 6 may be maintained.

In another example, the substrate 100 may be transported to a drying device (not shown) to be dried. Within the drying device, any residual solvent in the coating layer 120 may be removed.

In a secondary battery manufacturing process, as a coating speed of slurry discharged from the coating device and/or as an amount of slurry dispensed increases, a dispersion of the mass per area (i.e., a loading level) of the slurry may increase, thereby decreasing a coating quality of secondary battery electrode plates. Thus, if the slurry is not applied uniformly to the substrate or is not coated at a predetermined coating thickness, the reliability of secondary batteries may be reduced. For example, the thickness of the coating layer of a positive electrode plate or a negative electrode plate may be thinner at the edge portion than at the central portion. In such a case, the positive electrode plate or the negative electrode plate may not achieve desired electrical characteristics, and a reliability of the secondary battery may be reduced.

The air blower according to some embodiments of the present disclosure may include a first air blower 210 configured to blow air to the top surface of the coating layer and a second air blower 220 configured to blow air to the opposite side surfaces of the coating layer. Accordingly, as the coating rate and/or the dispensing amount of the slurry increases, the edge portions of the coating layer that are not coated uniformly may be made uniform by the air blown by the first air blower 210 and the second air blower 220. As a result, the thickness of the central portion of the coating layer and the thickness of the edge portion of the coating layer may become substantially the same, thereby improving the uniformity of the coating.

In addition, the controller 10 may control the first air blower 210 and the second air blower 220 to adjust (i) the temperature of the air of the first air blower 210 and/or the temperature of the air of the second air blower 220 and/or (ii) the blowing speed of the air of the first air blower 210 and/or the blowing speed of the air of the second air blower 220, based on at least one of the width of the coating layer, the thickness of the coating layer, the properties of the slurry, or the transport rate of the substrate. With such a configuration, even though the slurry may change in the manufacturing process, the uniformity of the coating layer may be maintained for various coating conditions of the slurry. As a result, an energy density of the secondary battery may be improved, and the reliability of the secondary battery may be improved.

In addition, the first air blower may include a Z pattern of nozzles. In a case where an air blower such as an air knife is used, defects such as streaks may occur on the coating surface. However, the Z pattern of the first air blower is configured such that the start point and the end point thereof are on a virtual line passing through the center of the coating layer. Thus, the top surface of the coating layer may be formed flat when the Z pattern of nozzles is used, and the uniformity of the thickness of the coating layer may therefore be improved.

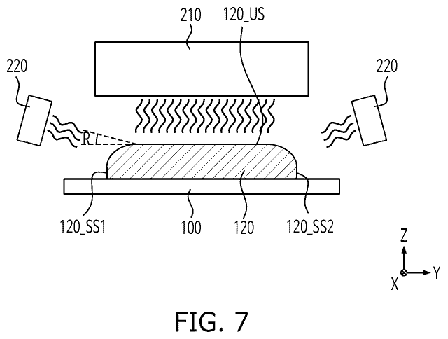

FIG. 7 is a cross-sectional view of the secondary battery manufacturing apparatus according to the present disclosure. For simplicity, the description of FIG. 7 will focus on the features of FIG. 7 that are different than features of FIG. 3. Referring to FIG. 7, the second air blower 220 may be spaced apart from the opposite side surfaces 120_SS1 and 120_SS2 of the coating layer 120. The second air blower 220 may blow air toward the opposite side surfaces 120_SS1 and 120_SS2 of the coating layer 120.

Unlike the second air blower 220 shown in FIG. 3, the second air blower 220 in FIG. 7 may blow air at a predetermined angle R with respect to the coating layer 120. The predetermined angle R may be an acute angle between the top surface 120_US of the coating layer 120 and a direction in which the second air blower 220 blows the air. The predetermined angle R may range from 0° to 90°.

The properties of the coating layer 120 may vary depending on mixing ratios of the materials forming the coating layer 120. For example, depending on a ratio of the materials forming the coating layer 120, a surface tension of the coating layer 120 may vary, and a curvature of each of the opposite side surfaces 120_SS1 and 120_SS2 of the coating layer 120 may vary. Accordingly, adjusting the second air blower 220 at the angle R of the second air blower 220 may planarize the opposite side surfaces 120_SS1 and 120_SS2 of the coating layer 120 and improve the uniformity of the coating layer 120.

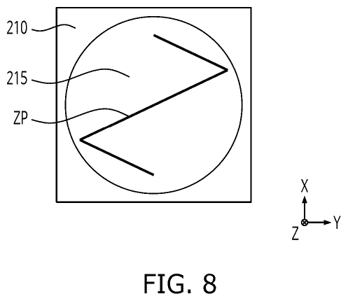

FIG. 8 is a plan view of the first air blower according to the present disclosure. For simplicity, the description of FIG. 8 will focus on the features of FIG. 8 that are different than features of FIG. 4. Referring to FIG. 8, the first air blower 210 according to some embodiments of the present disclosure may include nozzles in a Z pattern ZP and may further include a rotating member 215.

Unlike the nozzles in FIG. 4, the nozzles in the Z pattern ZP of FIG. 8 may be provided on a rotating member 215. The rotating member 215 may rotate the nozzles in the clockwise direction or in the counterclockwise direction. That is, in a case where the first air blower 210 blows air toward the top surface 120_US of the coating layer 120, the first air blower 210 may blow the air using the nozzles rotating clockwise or counterclockwise.

In some cases, the thickness of the edge portion of the coating layer may be excessively thin compared to the thickness of the central portion, depending on the surface tension of the slurry applied to the substrate. In such cases, a relatively large amount of slurry may be transferred from the central portion to the edge portion of the coating layer to improve uniformity of the coating layer. The first air blower may rotate the nozzles in the Z pattern ZP by the rotating member. The first air blower may increase the amount of slurry moving from the central portion of the coating layer to the edge portion of the coating layer and improve the uniformity of the coating layer by using centrifugal force caused by the rotation.

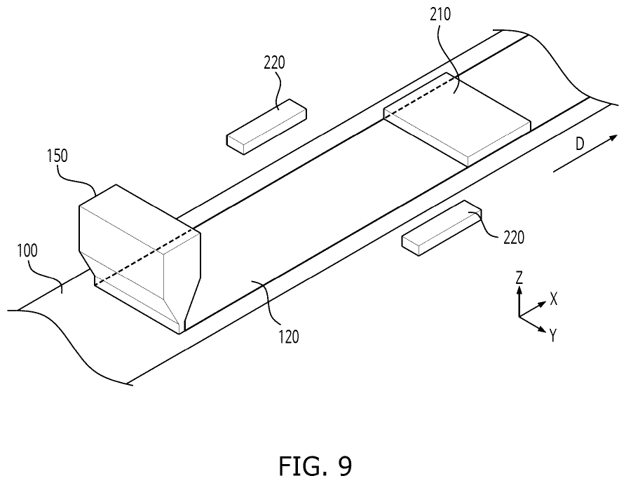

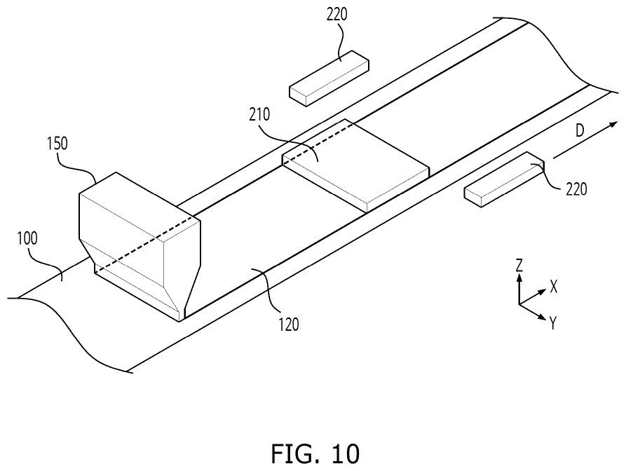

FIG. 9 is a perspective view of the secondary battery manufacturing apparatus according to embodiments of the present disclosure. FIG. 10 is also a perspective view of the secondary battery manufacturing apparatus according to embodiments of the present disclosure. For simplicity, the descriptions of FIGS. 9 and 10 will focus on the features of FIGS. 9 and 10 that are different than features of FIG. 2.

Referring to FIGS. 9 and 10, in the secondary battery manufacturing apparatus according to some embodiments, the first air blower 210 and the second air blower 220 may be spaced apart from each other in the transport direction D.

Unlike the first air blower 210 and the second air blower 220 of FIG. 2, the first air blower 210 and the second air blower 220 of FIG. 9 may be disposed sequentially in the transportation direction D such that the second air blower 220 is closer to the coating device 150 than the first air blower 210. In another example, unlike the first air blower 210 and the second air blower 220 of FIG. 2, the first air blower 210 and the second air blower 220 of FIG. 10 may be disposed sequentially in the transport direction D such that the first air blower 210 is closer to the coating device 150 than the second air blower 220.

In FIGS. 9 and 10, the first air blower 210 and the second air blower 220 are shown as not overlapping in the second direction Y, but embodiments having the first air blower 210 and the second air blower 220 are not limited thereto. For example, in some embodiments, the first air blower 210 and the second air blower 220 may partially overlap in the second direction Y.

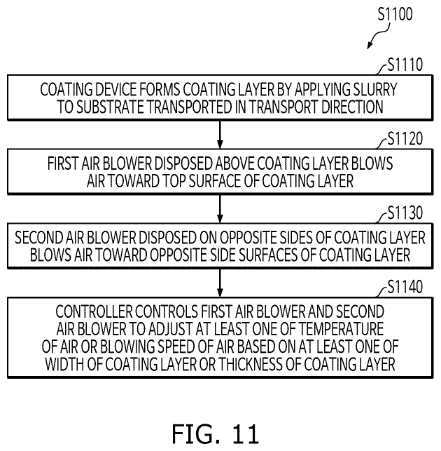

FIG. 11 is a method of manufacturing a secondary battery according to the present disclosure. The secondary battery manufacturing method S1100 may first begin with a step S1110 of applying slurry to a substrate being transported in a transport direction by a coating device to form a coating layer.

A second step S1120 may include blowing air using a first air blower disposed above the coating layer toward the top surface of the coating layer.

A third step S1130 may include blowing air out of using a second air blower disposed adjacent to opposite sides of the coating layer, toward opposite sides of the coating layer.

In some embodiments, the first air blower may blow air in a first straight line, blow air in a second straight line from an end of the first straight line, and blow air in a third straight line from an end of the second straight line. The first straight line and the third straight line may be parallel.

The controller may control the first air blower and the second air blower to adjust at least one of (i) the temperature of the air of the first air blower and/or the temperature of the air of the second air blower and/or (ii) the blowing speed of the air of the first air blower and/or the blowing speed of the air of the second air blower, based on at least one of the width of the coating layer or the thickness of the coating layer. The temperature of the air of the first air blower and/or the temperature of the air of the second air blower may each range from 80° C. to 150° C., but a temperature range of the air is not limited thereto.

In an embodiment, the controller may control the first air blower and the second air blower to adjust at least one of (i) the temperature of the air of the first air blower and/or the temperature of the air of the second air blower and/or (ii) the blowing speed of the air of the first air blower and/or the blowing speed of the air of the second air blower, based on the properties of the slurry.

In an embodiment, the controller may control the first air blower and the second air blower to adjust at least one of (i) the temperature of the air of the first air blower and/or the temperature of the air of the second air blower and/or (ii) the blowing speed of the air of the first air blower and/or the blowing speed of the air of the second air blower, based on the transport rate of the substrate.

The above-described exemplary embodiments of the present disclosure are disclosed for purposes of illustration, and a person having ordinary skill in the art will appreciate that various modifications, changes, and additions are possible within the spirit of the present disclosure.

A person having ordinary skill in the art will appreciate that various substitutions, modifications, and alterations are possible without departing from the technical ideas of the present disclosure, and the present disclosure is not limited by the foregoing embodiments and the accompanying drawings.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE SYMBOLS

10: controller
20: coating device
30: air blower
40: drying device
100: substrate
120: coating layer
150: coating device
210: first air blower
220: second air blower
ZP: Z pattern
D: transport direction

What is claimed is:

1. A secondary battery manufacturing apparatus comprising:
a coating device configured to form a coating layer by applying a slurry to a substrate being transported in a transport direction;
an air blower configured to blow air toward the coating layer; and
a controller configured to control the coating device and the air blower,
wherein the air blower includes a first air blower disposed above the coating layer and configured to blow air toward a top surface of the coating layer and a second air blower disposed adjacent to opposite sides of the coating layer and configured to blow air toward opposite side surfaces of the coating layer, and
wherein the controller is configured to adjust a temperature of the air from the first air blower and a temperature of the air from the second air blower based on at least one of a width of the coating layer or a thickness of the coating layer.

2. The secondary battery manufacturing apparatus as claimed in claim 1, wherein the temperature of the air from the first air blower or the temperature of the air from the second air blower ranges from 80° C. to 150° C.

3. The secondary battery manufacturing apparatus as claimed in claim 1, wherein the controller is configured to adjust a blowing speed of the air of the first air blower and a blowing speed of the air of the second air blower, based on at least one of the width of the coating layer or the thickness of the coating layer.

4. The secondary battery manufacturing apparatus as claimed in claim 1, wherein the controller is configured to adjust the temperature of the air from the first air blower and the temperature of the air from the second air blower based on properties of the slurry.

5. The secondary battery manufacturing apparatus as claimed in claim 3, wherein the controller is configured to adjust the blowing speed of the air from the first air blower and the blowing speed of the air from the second air blower based on properties of the slurry.

6. The secondary battery manufacturing apparatus as claimed in claim 1, wherein the controller is configured to adjust the temperature of the air from the first air blower and the temperature of the air from the second air blower based on a transport rate of the substrate.

7. The secondary battery manufacturing apparatus as claimed in claim 3, wherein the controller is configured to adjust the blowing speed of the air from the first air blower and the blowing speed of the air from the second air blower, based on a transport rate of the substrate.

8. The secondary battery manufacturing apparatus as claimed in claim 1, wherein the first air blower includes nozzles in a Z pattern.

9. The secondary battery manufacturing apparatus as claimed in claim 8, wherein the Z pattern includes a first straight line, a second straight line connected to the first straight line, and a third straight line connected to the second straight line, and the first straight line and the third straight line are parallel to each other.

10. The secondary battery manufacturing apparatus as claimed in claim 9, wherein a start point of the Z pattern is on a first virtual line, an end point of the Z pattern is on the first virtual line, and the first virtual line extends in the transport direction and passes through a center of the coating layer.

11. The secondary battery manufacturing apparatus as claimed in claim 10, wherein a first end of the first straight line is on the first virtual line, a second end of the first straight line is on a second virtual line, and the second virtual line extends in the transport direction along a first side surface of the coating layer.

12. The secondary battery manufacturing apparatus as claimed in claim 11, wherein a point where the second straight line and the third straight line meet is on a third virtual line, and the third virtual line extends in the transport direction along a second side surface of the coating layer.

13. The secondary battery manufacturing apparatus as claimed in claim 11, wherein a first end of the third straight line is on a third virtual line, a second end of the third straight line is on the first virtual line, and the third virtual line extends in the transport direction along a second side surface of the coating layer.

14. The secondary battery manufacturing apparatus as claimed in claim 8, wherein the first air blower includes a rotating member configured to rotate the nozzles in the Z pattern in a clockwise direction or in a counterclockwise direction.

15. The secondary battery manufacturing apparatus as claimed in claim 1, wherein the first air blower and the second air blower are spaced from each other in the transport direction.

16. A method of manufacturing a secondary battery comprising:
forming, using a coating device, a coating layer by applying slurry to a substrate transported in a transport direction;
blowing, using a first air blower disposed above the coating layer, air toward a top surface of the coating layer;
blowing, using a second air blower disposed adjacent to opposite sides of the coating layer, air toward opposite side surfaces of the coating layer; and
using a controller, at least one of (i) a temperature of the air from the first air blower and a temperature of the air from the second air blower or (ii) a blowing speed of the air from the first air blower and a blowing speed of the air from the second air blower, based on at least one of a width of the coating layer or a thickness of the coating layer.

17. The secondary battery manufacturing method as claimed in claim 16, wherein the controller adjusts the temperature of the air from the first air blower or the temperature of the air from the second air blower to a range from 80° C. to 150° C.

18. The secondary battery manufacturing method as claimed in claim 16, further comprising adjusting, using the controller, at least one of (i) the temperature of the air from the first air blower and the temperature of the air from the second air blower or (ii) the blowing speed of the air from the first air blower and the blowing speed of the air from the second air blower based on properties of the slurry.

19. The secondary battery manufacturing method as claimed in claim 16, further comprising controlling, using the controller, at least one of (i) the temperature of the air from the first air blower and the temperature of the air from the second air blower or (ii) the blowing speed of the air from the first air blower and the blowing speed of the air from the second air blower based on a transport rate of the substrate.

20. The secondary battery manufacturing method as claimed in claim 16, wherein blowing the air toward the top surface of the coating layer includes:
blowing the air in a first straight line;
blowing the air in a second straight line from an end of the first straight line; and
blowing the air in a third straight line from an end of the second straight line,
wherein the first straight line and the third straight line are parallel to each other.
